(19) United States
(12) Patent Application Publication
(10) Pub. No.: US 2018/0225256 A1
(43) Pub. Date: Aug. 9, 2018

(54) METHOD AND APPARATUS FOR OPTIMIZATION

(71) Applicant: Nokia Technologies Oy, Espoo (FI)

(72) Inventors: Troels Frimodt RONNOW, Cambridge (GB); Joachim WABNIG, Cambridge (GB)

(21) Appl. No.: 15/749,945

(22) PCT Filed: Sep. 4, 2015
(86) PCT No.: PCT/FI2015/050580

§ 371 Date: Feb. 2, 2018

(51) Int. Cl. G06F 17/11; G06N 99/00; G06N 7/00

(52) U.S. Cl. CPC G06F 17/11; G06N 7/005; G06N 99/002

(57) ABSTRACT

An approach is provided for solving optimization problems. The present invention also relates to a method comprising receiving a spin index and receiving one or more convergence criteria. The spin index is used to estimate an energy value; wherein the convergence criteria and the estimated energy value are used to determine whether the convergence criteria was fulfilled. There are also disclosed apparatuses for implementing the method and a computer readable storage medium stored with code thereon for implementing the method.

### TECHNOLOGICAL FIELD

The present invention relates generally to solving optimization problems. More particularly, the present invention relates to a method for finding a solution to binary optimization problems. The present invention also relates to apparatuses and computer program products for implementing the method and circuitry relating to the binary optimization.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Quadratic binary optimization (QUBO) is a particular type of problems. Such problems may be both extremely awkward for digital computers and important. Many cutting-edge artificial intelligence (AI) involves solving such problems. A Boltzmann machine may solve binary optimization and may accelerate sampling from a Boltzmann distribution.

An aim of the quadratic binary optimization is to minimize a quadratic function in which decision variables may only take certain discrete values, such as +1 and −1. The idea of quadratic binary optimization may be adapted to different kinds of programmable circuits. Quadratic binary optimization problems may arise in operational research such as planning, scheduling, routing, finance such as portfolio optimization, physics such as spin glass, machine learning and many more.

### SOME EXEMPLARY EMBODIMENTS

Examples of hardware architecture for discrete optimization and a programming method are provided. Specifically, examples are provided which represent a variant of quadratic binary optimization.

An aim is to obtain an apparatus and method for solving optimization problems.

According to one embodiment, an apparatus comprises
a first input for receiving a spin index;
a third input for receiving one or more convergence criteria;
an energy estimation block adapted to use the spin index to estimate an energy value; and
a convergence estimation block adapted to use the convergence criteria and the estimated energy value to determine whether the convergence criteria was fulfilled.

According to one embodiment, a method comprises
receiving a spin index;
receiving one or more convergence criteria;
using the spin index to estimate an energy value; and
using the convergence criteria and the estimated energy value to determine whether the convergence criteria was fulfilled.

According to one embodiment, an apparatus comprises at least one processor; and at least one memory including computer program code the at least one memory and the computer program code configured to, with the at least one processor, cause the apparatus to perform at least the following:
receive a spin index;
receive one or more convergence criteria;
use the spin index to estimate an energy value; and
use the convergence criteria and the estimated energy value to determine whether the convergence criteria was fulfilled.

According to one embodiment there is provided a computer readable storage medium stored with code thereon for use by an apparatus, which when executed by a processor, causes the apparatus to perform:
receive a spin index;
receive one or more convergence criteria;
use the spin index to estimate an energy value; and
use the convergence criteria and the estimated energy value to determine whether the convergence criteria was fulfilled.

According to one embodiment, an apparatus comprises:
means for receiving a spin index;
means for receiving one or more convergence criteria;
means for using the spin index to estimate an energy value; and means for using the convergence criteria and the estimated energy value to determine whether the convergence criteria was fulfilled.

Still other aspects, features, and advantages of the invention are readily apparent from the following detailed description, simply by illustrating a number of particular embodiments and implementations.

The invention is also capable of other and different embodiments, and its several details can be modified in various obvious respects, all without departing from the spirit and scope of the invention. Accordingly, the drawings and description are to be regarded as illustrative in nature, and not as restrictive.

There are provided examples of architectures for quantum annealing at finite temperature.

### BRIEF DESCRIPTION OF THE DRAWINGS

The embodiments of the invention are illustrated by way of example, and not by way of limitation, in the figures of the accompanying drawings:

FIG. 1a illustrates a fully connected graph for a single simulated annealing slice;

FIG. 1b illustrates a fully connected path for a quantum annealing system using time discretization;

FIG. 2 depicts a simulated annealing unit for updating spins in the Ising model based on converged criteria, in accordance with an embodiment;

FIG. 3 the operation of the simulated annealing unit as a flow diagram, in accordance with an embodiment;

FIG. 4a shows an embodiment as a part of a system on a chip in which one or more simulated annealing slices are used as a part of the chip, in accordance with an embodiment;

FIG. 4b shows an embodiment as a standalone chip, in accordance with an embodiment;

FIG. 4c shows an embodiment as a part of a system on a chip with additional observables, in accordance with an embodiment;

FIG. 4d shows an embodiment as a chip with custom observables, in accordance with an embodiment; and

FIG. 5 is a diagram of some components of a computing apparatus comprising the computational architecture for binary optimization according to an exemplary embodiment.

### DESCRIPTION OF EXAMPLE EMBODIMENTS

In the following description, for the purposes of explanation, some specific details are set forth in order to provide a thorough understanding of the embodiments of the invention. It is apparent, however, to one skilled in the art that the embodiments may be practiced without these specific details or with an equivalent arrangement. In other instances, well-known structures and devices are shown in block diagram form in order to avoid unnecessarily obscuring the embodiments of the invention.

Embodiments are provided to show how to implement in hardware quadratic binary optimization.

Binary optimization problems may occur in many fields of science and technology. Many scheduling and routing and planning tasks are binary optimization problems. Also problems in the field of machine learning can be formulated as binary optimization problems. One type of a problem encountered in binary optimization and machine learning is that of minimizing binary quadratic functionals

$$E = {\sum }_{i}^{N} {\sum }_{j}^{i - 1} {ω}_{ij} {b}_{i} {b}_{j} + {\sum }_{i}^{N} {a}_{i} {b}_{i} \qquad ( 1 )$$

where bᵢ are binary variables and {wᵢⱼ} and {aᵢ} define a problem of interest. The minimization problem of Equation (1) is equivalent to finding the optimal configurations of an Ising spin glass with an energy functional given by

$$H = {\sum }_{i}^{N} {\sum }_{j}^{i - 1} {J}_{ij} {s}_{i} {s}_{j} + {\sum }_{i}^{N} {h}_{i} {s}_{i} \qquad ( 2 )$$

where Jᵢⱼ and hᵢ are floating points (possibly negative) and sᵢ are representing physical spins that can either be up or down. The variables Jᵢⱼ represent interactions between spins sᵢ and sⱼ and hᵢ represents an external field affecting to the spin sᵢ.

Every configuration s yields a corresponding energy Eₛ≡H(s) which is minimal if s is an optimal solution. Often the optimal solution is not found and it is therefore instructive to use the residual energy Eᵣₑₛ=E(s)−Eₒₚₜ as a measure of how a given algorithm perform.

Many different techniques may be used to obtain good solutions for Equation (1) including using standard programming techniques such as divide-and-conquer, backtracking, heuristic searches, quantum optimization hardware and in particular quantum annealing.

In quantum annealing, one tries to find the optimal solution to Equation (2) through an evolution of

$${H}_{Q} = A ( t ) {H}_{D} + B ( t ) {H}_{P} with \qquad ( 3 )$$

where H_{P} replaces the original problem in Equation (2) and σ^{z} and σ^{x} are Pauli operators. If one uses a coherent unitary evolution, it may not be possible to simulate this system much beyond 30 variables (or spins). However, simulating the thermal equilibrium distribution may be done with Monte Carlo methods for thousands of variables. In particular, if one splits the path-integrals by discretizing the imaginary time, one may arrive at a model which reads

$$\begin{matrix}{H}_{Qcl} = {\sum }_{k = 1}^{M} ( {\sum }_{i = 1}^{N} {γ}_{i} {s}_{i}^{( k )} {s}_{i}^{( k + 1 )} + {\sum }_{i < j} {J}_{ij} {s}_{j}^{( k + 1 )} {s}_{j}^{( k + 1 )} + {\sum }_{i = 1}^{N} {h}_{i} {s}_{i}^{( k + 1 )} ) \\ where γ = B / Δ τ with & ( 5 ) \\ B ( Δ τ Γ ) = - \frac{1}{2} ln ( tan h ( Δ τ Γ ) ) & ( 6 )\end{matrix}$$

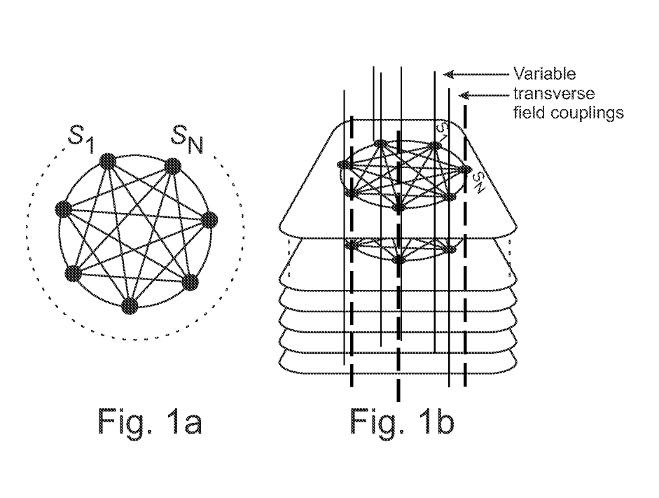

and Δτ=β/m for a discretization using M Trotter slices. If the original problem in Equation (2) is described in D dimensions, the corresponding Trotterised problem in Equation (5) is similar to that of Equation (2), but in D+1 dimensions. This is illustrated in FIGS. 1a and 1b. FIG. 1a illustrates a fully connected graph for a single simulated annealing slice and FIG. 1b illustrates a fully connected path for the quantum annealing system using time discretization. Simulation of quantum annealing in this formulation may be performed, for example, as discrete time quantum Monte Carlo annealing (DTQ). If Equation (5) would only consist of the two last terms in the sum over k, this equation would just describe M independent identical problems. The additional term serves to pairwise couple identical spins between two neighboring replicas.

Implementing quantum annealing in physical hardware may be expensive and may suffer from several limitations such as limited connectivity, calibration and programming errors, and may perform worse than similar classical optimizers.

In the following a more detailed description is provided of a design using complementary metal oxide semiconductor (CMOS) technology which may be fast, may have high connectivity and may use little logic. In accordance with an embodiment, a simulated annealing apparatus may simulate certain behavioral aspects by mimicking quantum tunneling using the discretized Monte Carlo approach described above. Furthermore, for ordinary simulated annealing full connectivity may be hard to realize in hardware implementations. The following approach may solve this problem as well, although the same circuit may also be used for lower degrees of connectivity.

In simulated annealing of an Ising spin glass a spin sᵢ changes sign based on the criteria

r<exp(−βΔEᵢ) (7)

where r is a random number between 0 and 1, β=T⁻¹ is the inverse temperature and ΔEᵢ is given by

$$Δ {E}_{i} = - 2 {s}_{i} ( {h}_{i} + {\sum }_{j}^{N} {J}_{ij} {s}_{j} ) \qquad ( 8 )$$

Let the couplings Jᵢⱼ be on the interval [−1; 1] and represent it using B bits of precision as

$${J}_{ij} = - 1 + {\sum }_{b = 0}^{B} {J}_{ij}^{( b )} {2}^{- b} \approx \frac{1}{2} {\sum }_{b = 0}^{B} ( 2 {J}_{ij}^{( b )} - 1 ) {2}^{- b} \qquad ( 9 )$$

with Jᵢⱼ^{(b)} being binary variables describing the value of Jᵢⱼ. The criteria in Equation (7), can now be recast in the form

$$T log ( r ) < 2 {s}_{i} ( {h}_{i} + \frac{1}{2} {\sum }_{j}^{N} {s}_{j} {\sum }_{k = 0}^{B} ( 2 {J}_{ij}^{( k )} - 1 ) {2}^{- k} ) \qquad ( 10 )$$

After interchanging the sums, the criteria can be expressed in bit-wise operations

$$T log ( r ) - 2 {s}_{i} {h}_{i} < {s}_{i} {\sum }_{k = 0}^{B} {2}^{- k} {\sum }_{j}^{N} {s}_{j} ( 2 {J}_{ij}^{( k )} - 1 ) = {s}_{i} {\sum }_{k = 0}^{B} {2}^{- k} {\sum }_{j}^{N} ( 2 {b}_{j} - 1 ) ( 2 {J}_{ij}^{( k )} - 1 ) = {s}_{i} {\sum }_{k = 0}^{B} {2}^{- k} {\sum }_{j}^{N} ( 1 - 2 ( {b}_{j} + {J}_{ij}^{( k )} mod 2 ) ) {s}_{i} = {\sum }_{k = 0}^{B} {2}^{- k} [ N - 2 P ( b ⊕ {J}_{i}^{( k )} ) ] = {\sum }_{k = 0}^{B} {2}^{- k} {ɛ}_{i}^{( k )} \\ with \\ {ɛ}_{i}^{( k )} = {s}_{i} [ N - 2 P ( b ⊕ {J}_{i}^{( k )} ) ] \qquad ( 11 )$$

where b and Jᵢ^{(k)} are N-bit vectors representing the k'th bit contribution of interaction of the i spin to all other spins in the system. The function P(x) is a population count function which counts number of bits with value 1. Notably,

N≤εᵢ^{(k)}≤N (12)

It may now be possible to compute the energy difference ΔEᵢ to any desired precision, and it may therefore be useful to introduce a partial estimate of ΔEᵢ^{(t)} as

$$- Δ {E}_{i}^{( t )} = 2 {s}_{i} {h}_{i} + {\sum }_{k = 0}^{t} {2}^{- k} {ɛ}_{i}^{( k )} \qquad ( 13 )$$

Then, the two possible solutions for Equation (10) may be separated at T log(r)+ΔEᵢ=0. For an approximation using t bits the left-hand side is bound from above as

$$T log ( r ) + Δ {E}_{i}^{( t )} = {\sum }_{k = t + 1}^{B} {2}^{- k} {ɛ}_{i}^{( k )} \leq N {\sum }_{k = t + 1}^{B} {2}^{- k} < 2 N {2}^{- t - 1} \qquad ( 14 )$$

Likewise, the lower bound may be found as

$$T log ( r ) + Δ {E}_{i}^{( t )} = {\sum }_{k = t + 1}^{B} {2}^{- k} {ɛ}_{i}^{( k )} \geq - N {\sum }_{k = t + 1}^{B} {2}^{- k} > - 2 N {2}^{- t - 1} \qquad ( 15 )$$

To determine whether the criteria of Equation (10) is fulfilled, the number of iterations t of the partial estimate ΔEᵢ^{(t)} may be chosen such that

|T log(r)+ΔEᵢ^{(t)}|>2N2^{-t-1}=N2^{-t} (16)

This criteria may be fulfilled long before exhausting all the B bits making it a much more efficient method to evaluate the flipping criteria of Equation (7). This idea may be extended to include a penalty term in the local energy difference ΔEᵢ which may make this approach directly applicable to the original problem in Equation (5).

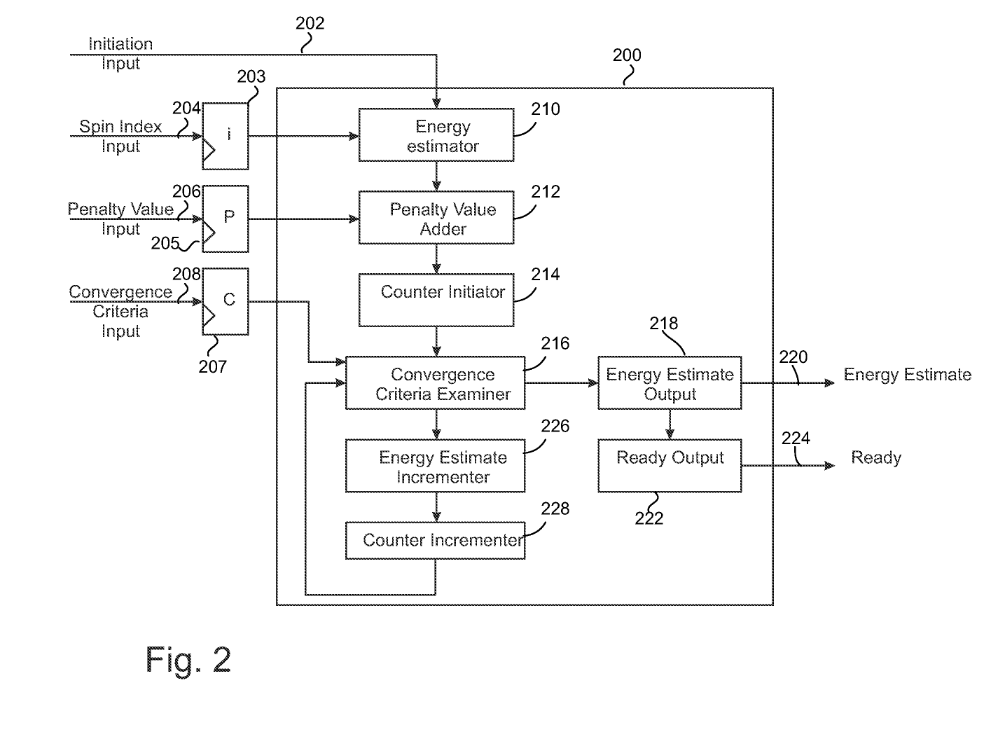

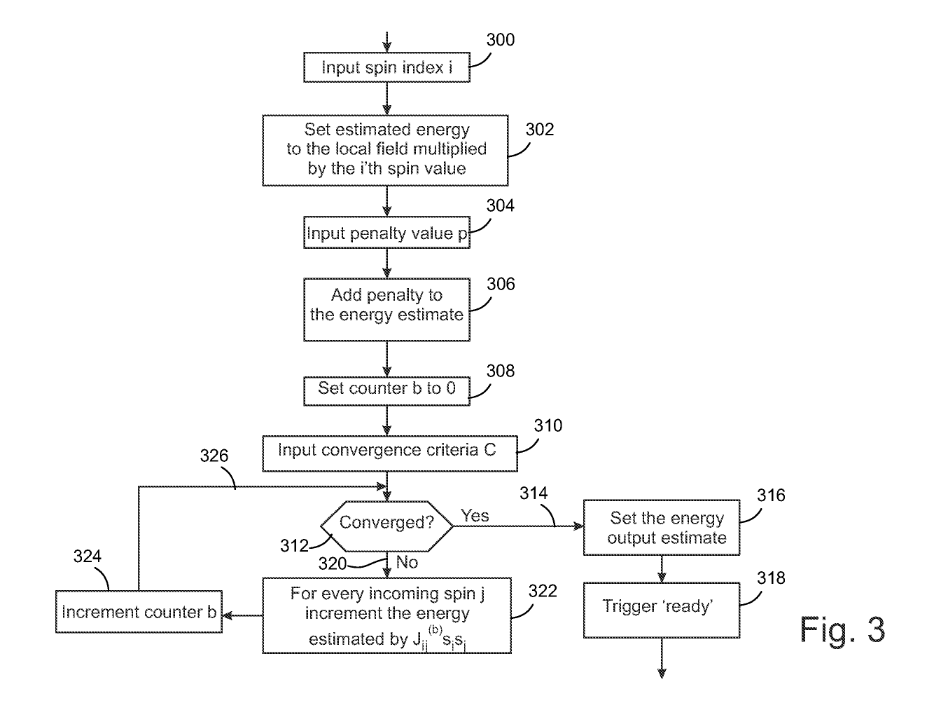

Next, it will be summarized how this approach could be incorporated into a field programmable gate array (FPGA) or an application specific integrated circuit (ASIC) to accelerate the performance of the algorithm. FIG. 2 depicts a simulated annealing unit 200 for updating spins in the Ising model based on converged criteria, in accordance with an embodiment, and FIG. 3 illustrates the operation of the simulated annealing unit 200 as a flow diagram, in accordance with an embodiment. In FIG. 2, it is shown as a block diagram how the inner most IP core would look like for an ASIC, with four incoming signals and two out-going signals. This circuit may then be deployed in parallel or alternatively sequentially. In accordance with an embodiment, all spins may be updated once or more using the described spin-update unit as a simulated annealing slice (SA slice).

The simulated annealing unit 200 may comprise an initiation input 202 for initiating the operation of the circuitry of the simulated annealing unit 200 (block 300 in the flow diagram of FIG. 3). The simulated annealing unit 200 may further comprise an input 204 for a spin index, an input 206 for a penalty term, and an input 208 for convergence criteria. The spin index input 204, the penalty term input 206, and the convergence criteria input 208 may be connected to latches 203, 205, 207, respectively, to latch the input signals, wherein outputs of the latches 203, 205, 207 may be coupled to corresponding blocks of the simulated annealing unit 200.

The initiation input 202 may be coupled to an energy estimation block 210. Also the spin index input 204 may be coupled via the latch 203 to the energy estimation block 210, wherein the energy estimation block 210 may set 302 estimated energy to a local field multiplied by the i'th spin value. The value of the estimated energy may be provided to a penalty adding block 212, which also receives 304 the penalty term from the penalty term input 206 via the latch 205 and adds 306 the penalty term to the estimated energy value. A counter initialization block 214 may initiate 308 a counter b to an initialization value, which may be, for example, 0. The sum of the estimated energy and the penalty term may be provided to a convergence estimation block 216. The convergence estimation block 216 may receive a convergence criteria from the convergence criteria input 208 via the latch 207 and use the convergence criteria to determine 310 whether the sum of the estimated energy and the penalty term converges or not. If the convergence estimation block 216 determines 312 that the sum of the estimated energy and the penalty term converges, the convergence estimation block 216 may provide 314 the sum of the estimated energy and the penalty term to an energy output estimation block 218. The energy output estimation block 218 may provide 316 the energy estimate to an energy estimate output 220 and initiate 318 a ready triggering block 222 to form a ready signal at a ready signal output 224 to indicate that the simulated annealing unit 200 has obtained an energy estimate.

However, if the convergence estimation block 216 determines 320 that the sum of the estimated energy and the penalty term does not converge, an increment block 226 may increment 322 the energy estimate for every incoming spin j by Jᵢⱼ^{(b)}sᵢsⱼ. A counter incrementing block 228 may increment 324 the counter b, and the incremented energy estimate is provided 326 to the convergence estimation block 216. Hence, the convergence estimation block 216 may now again determine, whether the incremented energy estimate fulfills the convergence criteria.

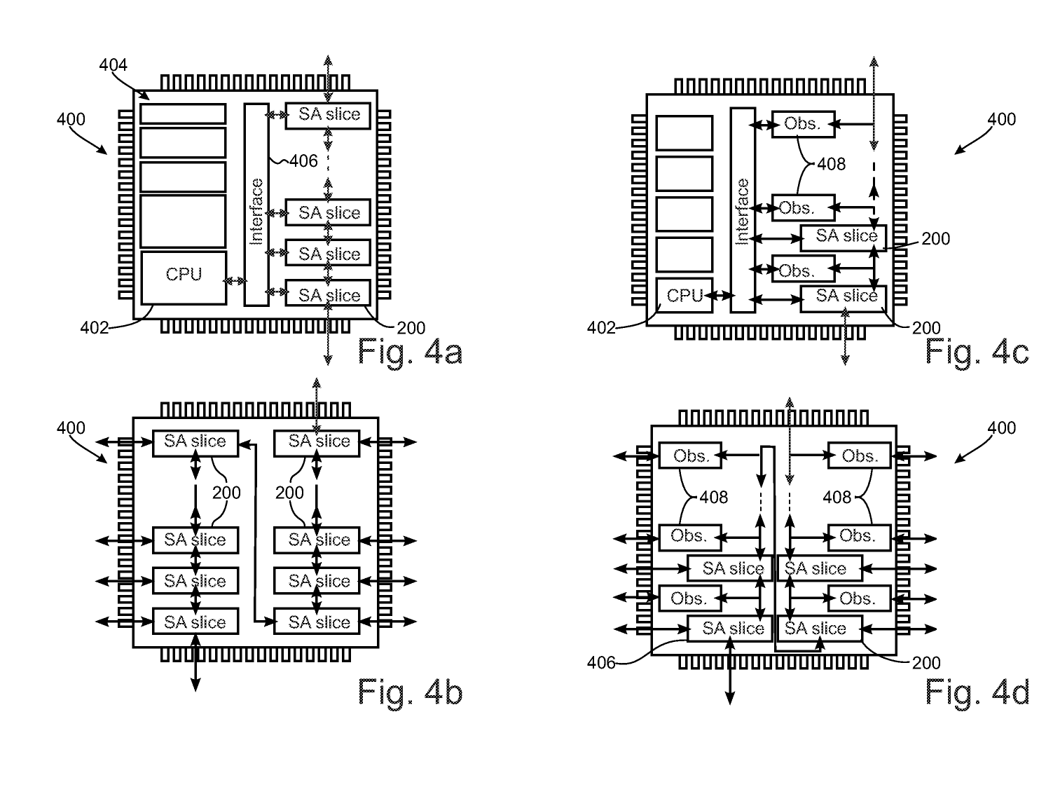

If the apparatus is used as a classical simulated annealer the penalty term may be taken to zero. However, if a simulated quantum annealing unit as in Equation (5) would be implemented, many simulated annealing slices may be put together linking through the penalty term. FIGS. 4a to 4d illustrate some possible embodiments of the simulated annealing apparatus. FIG. 4a shows an embodiment as a part of a system on a chip (SoC) 400 in which one or more simulated annealing slices 200 are used as a part of the chip 400. The chip 400 may thus also comprise, for example, a controller 402 (CPU, central processing unit) and/or other building blocks 404, such as memory. The chip 400 may further comprise an interface 406 for transferring signals between the simulated annealing slices 200 and the controller 402 and/or other building blocks 404 of the chip 400. FIG. 4b shows an embodiment as a standalone chip. In other words, the chip 400 comprises a multiple of simulated annealing slices 200. FIG. 4c shows an embodiment as a part of a system on a chip with additional observables 408. FIG. 4d shows an embodiment as a chip with custom observables 408. The embodiments may be performed such that a simulation unit (for instance a printed circuit board (PCB)) can be extended over several integrated chips or field programmable gate arrays (FPGA). The system on a chip implementation may include a communication interface to extend the number of simulated annealing slices, and may or may not include dedicated units to compute observables such as correlators, minimum energy found over time etc. The standalone chips may include a programming interface and may or may not include an interface to extend the number of simulated annealing slices over several chips. Likewise, the standalone chips may or may not include dedicated circuits to measure observables.

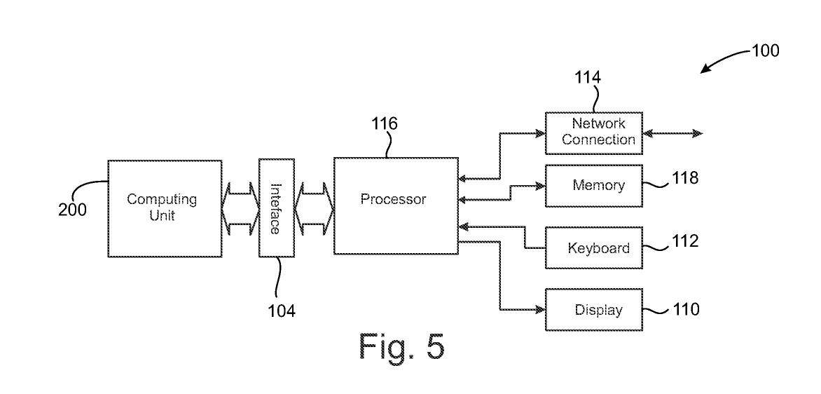

FIG. 5 illustrates an example of a computing device 100 in which the computing circuitry 200 may be utilized. The computing device 100 may comprise the computing circuitry 200 implemented e.g. in a FPGA circuit or another programmable circuitry. The inputs and outputs of the computing circuitry 200 may be connected to an interface circuitry 104 which comprises means for providing information to the computing circuitry 200, e.g. to initialize some parameters and initial values for the couplings Jᵢⱼ e.g. by setting local floating point memory into appropriate values, and for obtaining information from the computing circuitry 200. Information obtained from the computing circuitry 200 may comprise e.g. computation results.

The computing device 100 may also comprise a display 110 for displaying information to the user, and a keyboard 112 and/or another input device so that the user may control the operation of the computing device 100 and input parameters, variables etc. to be used by the computing circuitry 102. There may also be communication means 114 for communicating with a communication network such as the internet, a mobile communication network and/or another wireless or wired network.

There may also be provided a processor 116 for controlling the operation of the computing device and the elements of the computing device. In accordance with an embodiment, the processor 116 may be implemented in the same chip than the simulated annulation units 200, as is depicted in FIGS. 4a and 4c, wherein the interface 104 may also be part of the chip 400, or the processor 116 and possibly also the interface 104 may be separate from the chip 400. In accordance with an embodiment, the computing unit 200 may comprise one or more controllers in addition to the processor 116.

The term computer-readable medium is used herein to refer to any medium that participates in providing information to processor 116, including instructions for execution. Such a medium may take many forms, including, but not limited to, non-volatile media, volatile media and transmission media. Non-volatile media include, for example, optical or magnetic disks, such as storage device. Volatile media include, for example, dynamic memory 118. Transmission media include, for example, coaxial cables, copper wire, fibre optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIGS. 17 and 18. A computer-readable medium may comprise a computer-readable storage medium that may be any media or means that can contain or store the instructions for use by or in connection with an instruction execution system, apparatus, or device, such as a computer.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-17. (canceled)

18. An apparatus comprises at least one processor; and at least one memory including computer program code the at least one memory and the computer program code configured to, with the at least one processor, cause the apparatus to at least:
receive a spin index;
receive one or more convergence criteria;
use the spin index to estimate an energy value; and
use the convergence criteria and the estimated energy value to determine whether the convergence criteria was fulfilled.

19. The apparatus of claim 18, wherein the apparatus is further caused to obtain another estimate of the energy value, if the convergence criteria was not fulfilled.

20. The apparatus of claim 18, wherein the apparatus is further caused to:
add a penalty term to the estimated energy value, and
use the estimated energy value added with the penalty term in the convergence criteria determination.

21. The apparatus of claim 18, wherein the apparatus is further caused to increment the energy estimate for every incoming spin j by Jᵢⱼ^{(b)}sᵢsⱼ to obtain the another estimate of the energy value, where Jᵢⱼ^{(b)} is a binary variable describing the value of a coupling Jᵢⱼ.

22. The apparatus of claim 18, wherein the apparatus is further caused to find a minimum to an energy functional given by
$$H = {\sum }_{i}^{N} {\sum }_{j}^{i - 1} {J}_{ij} {s}_{i} {s}_{j} + {\sum }_{i}^{N} {h}_{i} {s}_{i} ,$$
where Jᵢⱼ and hᵢ are floating points, sᵢ represents a physical spin that can either be up or down, Jᵢⱼ represents interactions between spins sᵢ and sⱼ, and hᵢ represents an external field affecting to the spin sᵢ.

23. The apparatus of claim 22, wherein the couplings Jᵢⱼ are on the interval [−1; 1] as
$${J}_{ij} = - 1 + {\sum }_{b = 0}^{B} {J}_{ij}^{( b )} {2}^{- b} \approx \frac{1}{2} {\sum }_{b = 0}^{B} ( 2 {J}_{ij}^{( b )} - 1 ) {2}^{- b} ,$$
where Jᵢⱼ^{(b)} is a binary variable comprising B bits describing the value of Jᵢⱼ.

24. The apparatus of claim 18, wherein the apparatus is further caused to change value of a counter, if it was determined that the convergence criteria was not fulfilled.

25. A method comprising:
receiving a spin index;
receiving one or more convergence criteria;
using the spin index to estimate an energy value; and
using the convergence criteria and the estimated energy value to determine whether the convergence criteria was fulfilled.

26. The method of claim 25 further comprising:
obtaining another estimate of the energy value, if the convergence criteria was not fulfilled.

27. The method of claim 25, further comprising:
adding a penalty term to the estimated energy value, and
using the estimated energy value added with the penalty term in the convergence criteria determination.

28. The method of claim 25, further comprising:
incrementing the energy estimate for every incoming spin j by Jᵢⱼ^{(b)}sᵢsⱼ to obtain the another estimate of the energy value, where Jᵢⱼ^{(b)} is a binary variable describing the value of a coupling Jᵢⱼ.

29. The method of claim 25, further comprising:
finding a minimum to an energy functional given by
$$H = {\sum }_{i}^{N} {\sum }_{j}^{i - 1} {J}_{ij} {s}_{i} {s}_{j} + {\sum }_{i}^{N} {h}_{i} {s}_{i} ,$$
where Jᵢⱼ and hi are floating points, sᵢ represents a physical spin that can either be up or down, Jᵢⱼ represents interactions between spins sᵢ and sⱼ, and hᵢ represents an external field affecting to the spin sᵢ.

30. The method of claim 29, wherein the couplings Jij are on the interval [−1; 1] as
$${J}_{ij} = - 1 + {\sum }_{b = 0}^{B} {J}_{ij}^{( b )} {2}^{- b} \approx \frac{1}{2} {\sum }_{b = 0}^{B} ( 2 {J}_{ij}^{( b )} - 1 ) {2}^{- b} ,$$
where Jᵢⱼ^{(b)} is a binary variable comprising B bits describing the value of Jᵢⱼ.

31. The method of claim 25, further comprising:
changing a value of a counter, if it was determined that the convergence criteria was not fulfilled.

32. A non-transitory computer readable storage medium stored with code thereon for use by an apparatus, which when executed by a processor, causes the apparatus to perform:
receive a spin index;
receive one or more convergence criteria;
use the spin index a to estimate an energy value; and
use the convergence criteria and the estimated energy value to determine whether the convergence criteria was fulfilled.

33. The non-transitory computer readable storage medium of claim 32, wherein the apparatus is further caused to obtain another estimate of the energy value, if the convergence criteria was not fulfilled.

34. The non-transitory computer readable storage medium of claim 32, wherein the apparatus is further caused to:
add a penalty term to the estimated energy value, and
use the estimated energy value added with the penalty term in the convergence criteria determination.

35. The non-transitory computer readable storage medium of claim 32, wherein the apparatus is further caused to increment the energy estimate for every incoming spin j by Jᵢⱼ^{(b)}sᵢsⱼ to obtain the another estimate of the energy value, where Jᵢⱼ^{(b)} is a binary variable describing the value of a coupling Jᵢⱼ.

36. The non-transitory computer readable storage medium of claim 32, wherein the apparatus is further caused to find a minimum to an energy functional given by
$$H = {\sum }_{i}^{N} {\sum }_{j}^{i - 1} {J}_{ij} {s}_{i} {s}_{j} + {\sum }_{i}^{N} {h}_{i} {s}_{i} ,$$
where Jᵢⱼ and hᵢ are floating points, s represents a physical spin that can either be up or down, Jᵢⱼ represents interactions between spins sᵢ and sⱼ, and hᵢ represents an external field affecting to the spin sᵢ.

37. The non-transitory computer readable storage medium of claim 36, wherein the couplings Jᵢⱼ are on the interval [−1; 1] as
$${J}_{ij} = - 1 + {\sum }_{b = 0}^{B} {J}_{ij}^{( b )} {2}^{- b} \approx \frac{1}{2} {\sum }_{b = 0}^{B} ( 2 {J}_{ij}^{( b )} - 1 ) {2}^{- b} ,$$
where Jᵢⱼ^{(b)} is a binary variable comprising B bits describing the value of Jᵢⱼ.
